(19) United States
(12) Patent Application Publication
(10) Pub. No.: US 2014/0245351 A1
(43) Pub. Date: Aug. 28, 2014

(54) System For Booking Television Programs

(71) Applicants: Glen Ford, London (GB); Christopher Kirk, London (GB)

(72) Inventors: Glen Ford, London (GB); Christopher Kirk, London (GB)

(21) Appl. No.: 13/774,758

(22) Filed: Feb. 22, 2013

(51) Int. Cl. H04N 21/482

(52) U.S. Cl. CPC H04N 21/482
USPC 725/39

(57) ABSTRACT

A computer system in which a touch-screen display displays an electronic program guide to a user. A first user can book to watch a television program at a future time by selecting a “book to watch” button 56 on the EPG. The first user can then invite a number of contacts to watch the television program as well. Invitations are sent to the contacts' devices using a server, and an indication of those contacts that have accepted the invitation is displayed on an EPG associated with the first user.

### FIELD OF THE INVENTION

This invention relates to a computer system and a corresponding method for booking to view television programs with an Electronic Program Guide (EPG).

### BACKGROUND OF THE INVENTION

EPGs are commonly used in digital television so that a user can review scheduled television programs. Typically an EPG can be displayed on a television screen, a computer screen or a remote control. An EPG often includes a list of scheduled television programs, typically ranked by the ordinal number of the channel or by genre.

An EPG often includes a functionality to allow a user to set a reminder to view a television program that is scheduled at a future time, or to record the television program. In these systems a user can select a television program and then receive a reminder in advance of the scheduled start time or their set-top-box will begin recording at the scheduled time. In certain arrangements a set-top-box can automatically re-tune to the relevant channel at the scheduled start time.

With traditional broadcast television a number of viewers receive and view television programs in their homes, entirely independently of one another. This model is somewhat out of step with developments in interconnected social networks where users can engage with their peers. It would be desirable to provide a mechanism for booking to watch future television programs that also allows viewers to connect and interact with their peers.

### SUMMARY OF THE INVENTION

According to the present invention there is provided a computer system comprising: an input module configured to receive a selection of a television program from a first user; and one or more processors configured to send an invitation to one or more contacts, inviting them to select the television program as well.

In this way the first user can invite a number of friends to participate in a group viewing event. Each invitation can include details of the television program and its designated start time. By accepting the invitation the friends or contacts can indicate their intention to watch the television program. Thus, the organiser and recipients of the invitation can feel as though they are watching the television program together, even though they are physically separated.

The invitation may be closed in the sense that it is delivered only to a specified selection of contacts. The invitation may also be open in the sense that it is accessible to an unrestricted group of contacts. An open invitation may be sent to a group of users by posting it on a website.

Preferably the one or more processors are configured to display an indication on a device associated with the first user of at least some contacts that have received and accepted the invitation. In this way the first user can see which of their contacts have accepted the invitation. The first user can therefore choose to interact with one or more of these friends based on the indication displayed on their device. The displayed indication may include all or a subset of the contacts that have received and accepted the invitation. Preferably the displayed indication shows at least one contact.

Preferably the indication is embedded in an electronic program guide (EPG) on the first user's device. Thus, when exploring the EPG the first user can easily see which television programs they have booked to watch, and which of their contacts have accepted their invitation. This can create an EPG that is personalised for each individual user.

In one arrangement the first user may decide to select the television program on the basis of a received invitation. The first user may then forward this invitation to other contacts in his address book. In these circumstances the displayed indication may include the contact that sent the invitation to the first user as well as a list of contacts that have received and accepted the forwarded invitation.

Preferably the one or more processors are configured to display an indication of the first user on a device associated with at least one of the contacts that received and accepted the invitation. The first user is preferably the organiser of a group viewing event. By displaying an indication of the first user on a device associated with a contact, the contact can appreciate that they are participating in a group viewing event with the first user. Preferably the indication of the first user is displayed alongside the relevant television program in a personalised EPG.

Preferably the indication displayed on the device associated with the at least one of the contacts also includes an indication of contacts that have received and accepted the invitation. Thus, each contact can easily review a list of all of the individuals that have accepted the invitation to participate in a group viewing event.

Preferably an indication of a contact is displayed on a relevant device when the invitation is accepted. Thus, a dynamic update may occur whenever a contact accepts an invitation.

The displayed indication of a contact preferably includes information regarding the contact's status. In one example the status of the contact may include whether the contact is online or offline. In a further example, the status of the contact may include the television program that the contact appears to be watching. The contact's status may be used by the first user when deciding whether to interact with the contact and/or whether to send the contact an invitation.

The one or more processors may be configured to launch an instant messaging application on the device associated with the first user. In this way, the first user and each contact can participate in an online chat about the content of the television program. The instant messaging application may be launched at the start time of the television program, or shortly before. A list of the contacts that have accepted the invitation may be displayed in the instant messaging application in addition to, or as an alternative, to the list of contacts displayed in the EPG. The list of contacts displayed in the instant messaging application may be a subset of the contacts that have accepted the invitation since some of the contacts that have accepted the invitation may subsequently be unavailable for participation in the instant messaging application. Further users may be able to participate in the instant messaging application, even if they did not receive an invitation.

Preferably the computer system includes a display configured to display an electronic program guide (EPG) to a user, and the one or more processors may be configured to modify the appearance of the EPG when the television program is selected by the first user. If the television program has a start time in the future then the EPG may be modified to indicate that the first user has “booked” to view the television program.

Preferably the display is configured to modify the appearance of the EPG when a contact accepts the invitation. The first user can therefore review their personalised EPG to see an indication of those contacts that have accepted their invitation.

Content may be launched at the first user's device, including a list of comments related to the television content from other users. In addition, the content may include a list of key terms that are related to the television content currently showing. The user may be able to engage with the television content by reviewing this content and communicating with their friends over the instant messaging application.

The computer system preferably includes a first user device comprising a display with which the first user can select the television program; a plurality of user devices, each comprising a display, and each associated with one of the contacts; and a server computer configured to communicate with the first user device and the plurality of user devices.

The one or more processors may be provided in the server computer and/or in at least one of the user devices. The tasks performed in the computer system can therefore be distributed in any convenient manner.

Where the television program is scheduled to be broadcast in the future the one or more processors may be configured to generate a reminder for the first user. The reminder may also include a list of contacts who have accepted the invitation. This may act as a prompt for the first user to begin watching the television program.

In a preferred embodiment the television program selected by the first user is scheduled to be shown at a future time. Thus, the invitations may invite contacts to book to view a program in the future. In an alternative configuration the television program may be playing and the invitations may be in relation to a current event.

The one or more processors may be configured to forward an invitation received by one or more of the contacts, and the one or more processors may also be configured to display an indication of contacts that have received and accepted the forwarded invitation. In this way the first user that initiated the invitation can see details of contacts that have accepted on the basis of a forwarded invitation. Preferably an indication of these contacts is also displayed on the device associated with the user that forwarded the invitation.

According to another aspect of the invention there is provided a method of creating a group television viewing event comprising the steps of: receiving a selection of a television program from a first user; sending an invitation to one or more contacts, inviting them to select the television program as well; and receiving one or more selections of the television program from the invited contacts.

According to yet another aspect of the invention there is provided a computer readable storage medium having a computer program stored thereon, the computer program comprising processor readable instructions that, when executed, direct a device to perform actions comprising: receiving a selection of a television program from a first user; sending an invitation to one or more contacts, inviting them to select the television program as well; and receiving one or more selections of the television program from the invited contacts.

According to yet another aspect of the invention there is provided a computer system comprising: an input module configured to receive a number of selections of television programs scheduled to be shown at respective future times; one or more processors configured to create a list of television programs scheduled to be shown at respective future times, and to rank the list according to the number of selections each television program has received; and a display configured to display the ranked list to a user.

Thus, it is possible to create a list of the most popular television programs that are due to be shown at a future time. This list may be based on selections made by users who intend to view the content. For example, it may be based on the number of reminders that users have set in respect of scheduled television programs.

The selection of a television program may involve setting a reminder to be notified in advance of the scheduled start time. Users may set reminders to ensure that they do not miss television content. These reminders may be taken as an indication of an intention to view the relevant program. A ranking module in a server computer may use these data in order to rank the list of future television programs in order of anticipated popularity.

The processors may be configured to list television programs scheduled to be shown within a predetermined time period. The predetermined time period may be seven days, starting from the current time. Thus, a user can review the most popular television programs scheduled to be shown in the next week and use this information when deciding their own viewing schedule.

The processors may be configured to rank the list according to the number of selections each television program has received from a specific group of users. The specific group of users may be a group of friends or celebrities. Thus, a user may choose to rank the list of television programs according to their popularity within this restricted group, rather than their wider popularity.

According to another aspect of the invention there is provided a method comprising the steps of: receiving a number of selections of television programs scheduled to be shown at respective future times; creating a list of television programs scheduled to be shown at respective future times; ranking the list according to the number of selections each television program has received; and display the ranked list to a user.

According to yet another aspect of the invention there is provided a computer readable storage medium having a computer program stored thereon, the computer program comprising processor readable instructions that, when executed, direct a device to perform actions comprising: receiving a number of selections of television programs scheduled to be shown at respective future times; creating a list of television programs scheduled to be shown at respective future times; ranking the list according to the number of selections each television program has received; and display the ranked list to a user.

Apparatus features may be provided as corresponding method features and vice-versa.

### BRIEF DESCRIPTION OF THE DRAWINGS

Embodiments of the present invention will now be described, by way of example only, with reference to the accompanying drawings in which:

FIG. 1 is a schematic view of client and server devices in a network in an embodiment of the present invention;

FIG. 2 is a schematic view of the components in a client device in an embodiment of the present invention;

FIG. 3 is a flow diagram showing a sequence of steps that can be performed in a an embodiment of the present invention;

FIG. 4 is a flow diagram showing a sequence of steps that can be performed in a another embodiment of the present invention;

FIGS. 5A, 5B and 5C are example screenshots showing an extract of an EPG in an embodiment of the invention; and

FIG. 6 is an example screenshot showing a graphical user interface that can allow a user to select contacts that will receive an invitation.

### DETAILED DESCRIPTION OF THE INVENTION

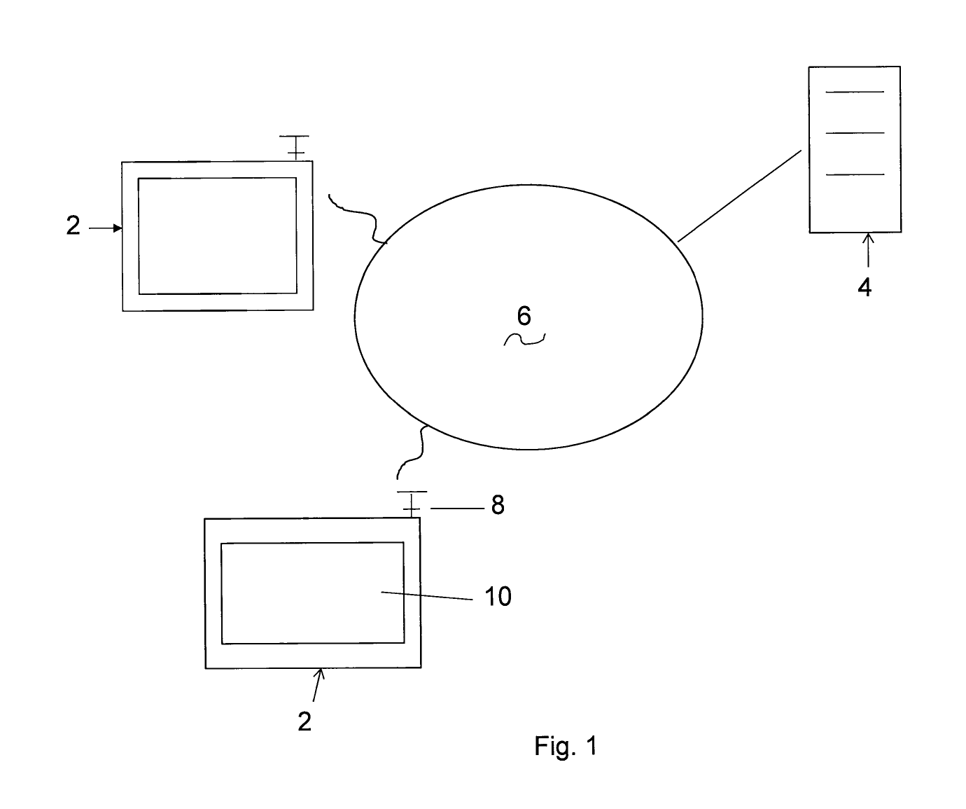

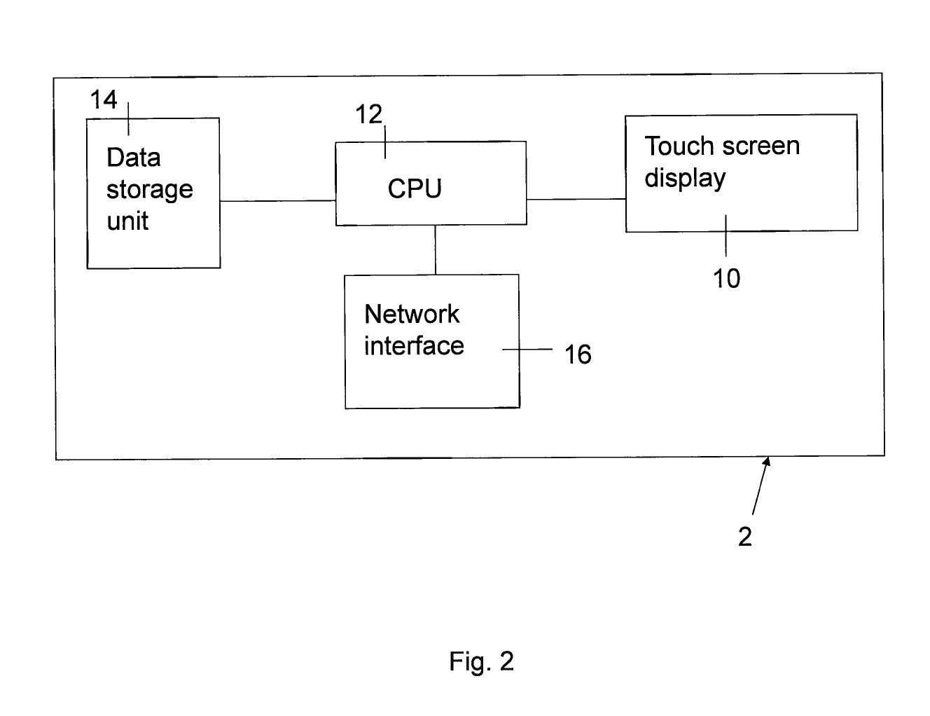

FIG. 1 is a schematic view of a number of client devices 2 and a server computer 4 in communication over a network 6 such as the internet. Each client device 2 includes an aerial 8 or other means for use in transmitting and receiving data over the network 6. The client device 2 also includes a touch-screen 10 that can be used both for displaying an EPG to a user and for receiving user input; in other embodiments a passive screen can be used and some other means can be provided for receiving user input. Further detail of a client device 2 is provided in FIG. 2, from which it is clear that each client device 2 includes a central processing unit (CPU) 12, a data storage unit 14 and a network interface 16. In various embodiments the client devices 2 may be one or more of a tablet computing device, a personal digital assistant (PDA), a cellular telephone/smart phone, a personal computer or a television.

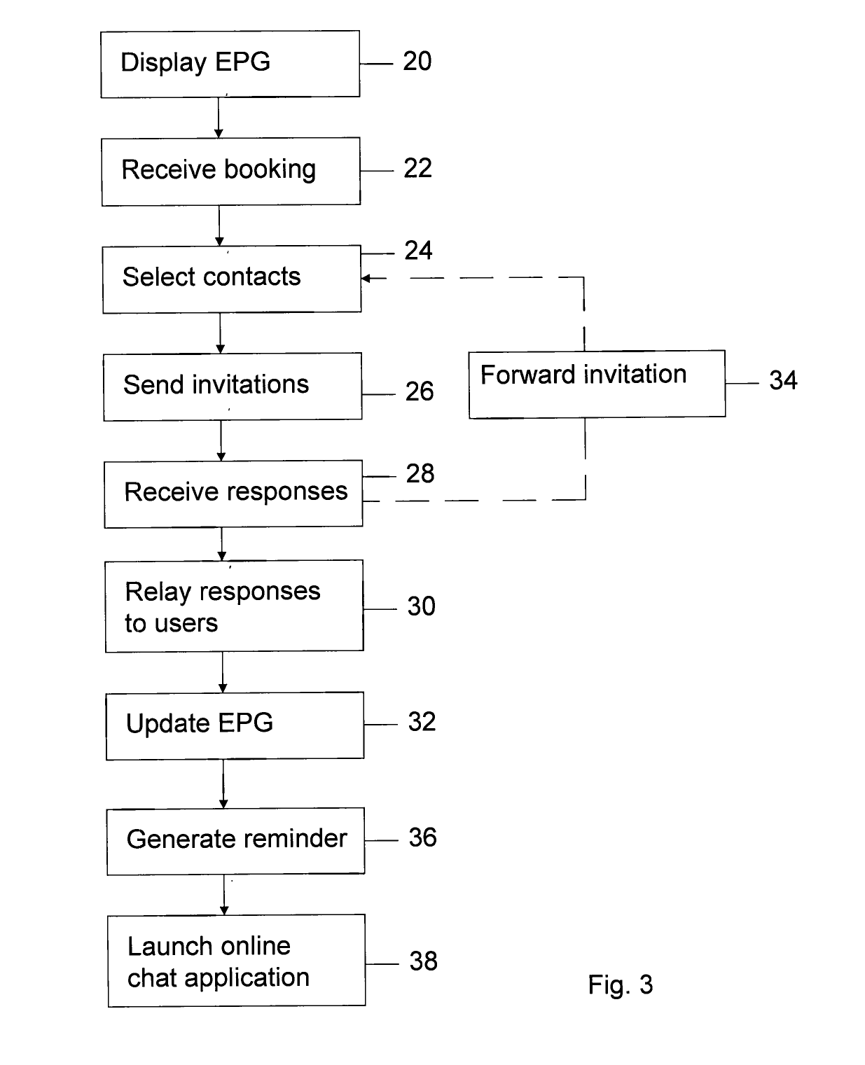

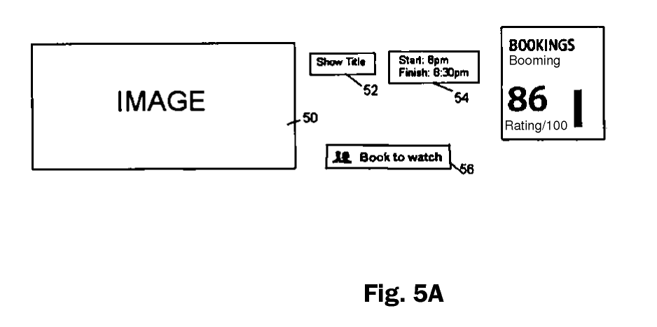

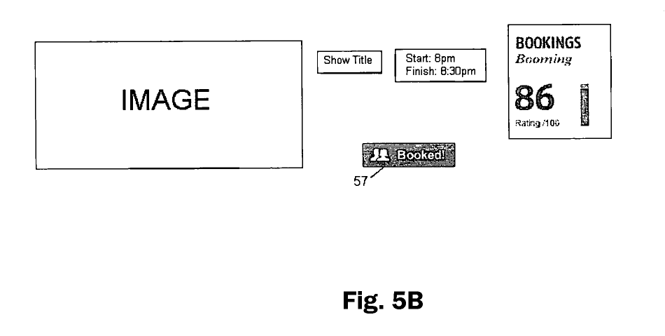

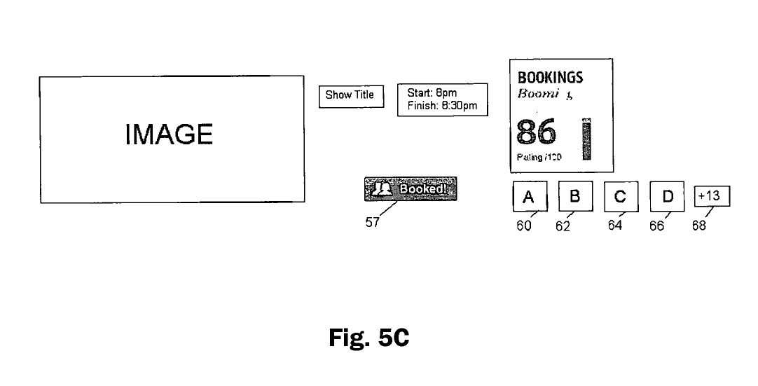

FIG. 3 is a flow diagram showing a sequence of steps that can be performed in an embodiment of the invention. At step 20 an EPG is displayed on the touch-screen 10 of a first user's client device 2. An extract from an EPG is shown in FIG. 5A showing the details for a particular program. For each program detailed in the EPG there is an image 50, a channel identifier (not shown), a title 52, a brief description (not shown), a start and end time 54, and a “book to watch” button 56.

At step 22 the client device 2 receives a booking for a television program when the first user selects the “book to watch” button 56 on the touch-screen 10. Upon selection the “book to watch” button 56 changes its appearance to read “booked” 57, as shown in FIG. 5B. The client device 2 therefore registers the first user's intention to watch the television program at the scheduled start time and can generate appropriate reminders. The client device 2 also communicates the user's booking to the server 4 over the network 6. Each client device 2 is typically in constant contact with the server 4 and can communicate further information such as whether the device is being used to determine whether the user is ‘online’, and which television program the user is currently watching.

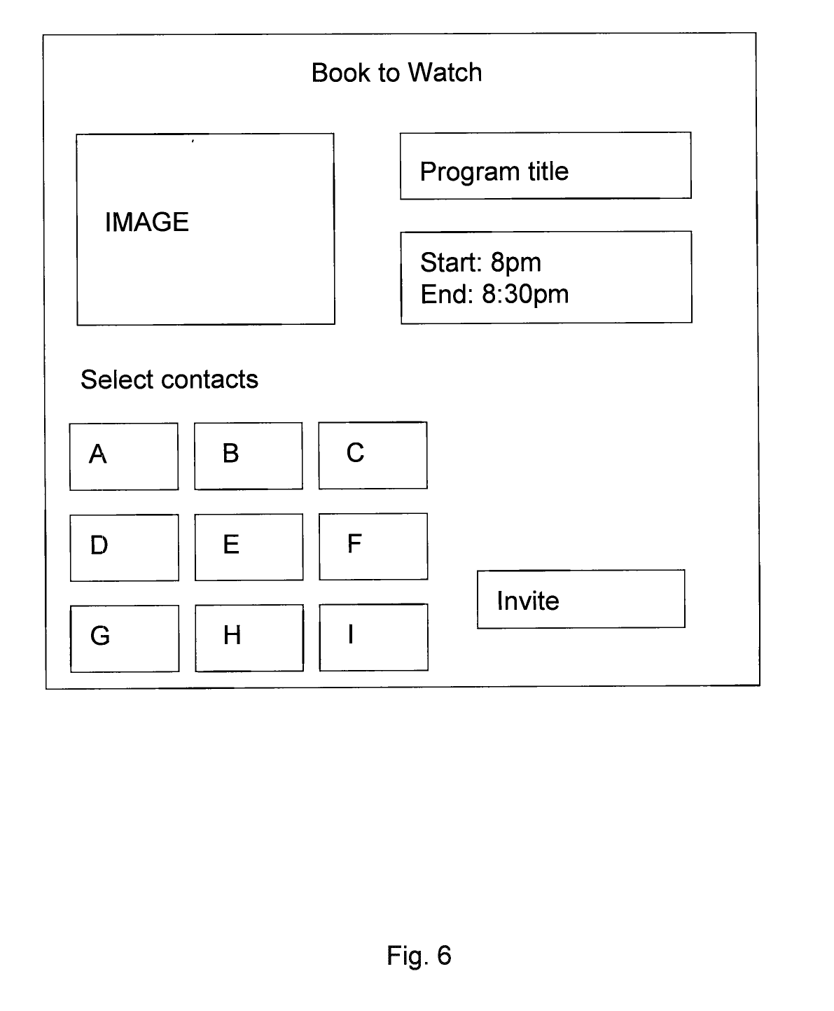

At step 24 the first user selects a number of contacts to whom an invitation will be sent. In this way the first user can invite contacts to make a booking as well. Thus, when the program starts all of the contacts that have accepted the invitation can participate in a group viewing session, even though they are physically remote from one another. FIG. 6 is an example screenshot showing the user interface that is presented to a user in order to allow them to select contacts that will receive an invitation. The user interface includes a list of contacts (A-I), displayed as thumbnail images or avatars, so that the first user can select one or more of these contacts. The list of selected contacts is then communicated from the client device 2 to the server 4 over the network 6.

In one arrangement the list of contacts (A-I) in the screenshot includes an indication of whether the each contact is currently online, and which television program the contact appears to be viewing. This may be useful to the first user when deciding which contacts should receive an invitation.

At step 26 the server 4 sends an invitation to the client device 2 associated with each of the contacts selected at step 24. The invitation includes details of the television program selected by the user together with a message informing the contact that they have been invited to participate in a group viewing event. Each recipient can respond by accepting, declining or ignoring the invitation. At step 28 the server 4 receives positive and negative responses from the invited contacts.

At step 30 the server 4 relays each acceptance and/or rejection of the invitation back to the client device 2 of the first user. At step 32 the CPU 12 of the client device 2 updates the displayed EPG to indicate the contacts that have accepted the invitation. FIG. 5C shows an extract from an EPG in which seventeen contacts have accepted an invitation. In this example, four icons 60, 62, 64, 66 are displayed in the EPG alongside the relevant television program to indicate four of the contacts that have accepted the invitation. Another icon 68 indicates that thirteen further contacts have accepted the invitation; this icon 68 can be selected on the touch-screen 10 to reveal the details of these contacts. Typically the icons 60, 62, 64, 66 include a thumbnail image or an avatar associated with the relevant contact.

At step 32, in a preferred arrangement, the server 4 relays each acceptance and/or rejection of the invitation to the client device 2 associated with each contact that received the invitation. Thus, the CPUs 12 of the relevant client devices 2 can modify the displayed EPG to indicate the contacts that have accepted the invitation and will be participating in the group viewing event. In this case the list of icons would include an indication of the first user.

In an alternative embodiment at step 30 the CPUs 12 in the relevant client devices 2 can modify the displayed EPG to include only an icon 60 associated with the first user. Thus, each invitee can only see an icon for the first user that sent the invitation. In this arrangement an invitee would not be able to see whether other contacts have accepted the invitation, which may be desirable depending on the contacts' privacy settings.

At step 34 each recipient of the invitation may decide to forward the invitation to a further selection of contacts. Alternatively, at step 34, a recipient could create a new invitation for the same television program. Following this optional path, the recipient would select a number of contacts at step 24. The new or forwarded invitation would then be sent by the server 4 to the relevant contacts at step 26. Thus, the invitation generation process is not necessarily linear because an initial invitation could be forwarded by multiple recipients. For a recipient who has forwarded an invitation it will be appreciated that the icons 60, 62, 64, 66 displayed in an EPG may be indicative of the contact that initiated an original invitation and/or the contacts that have accepted an original invitation and/or the contacts that have accepted subsequent forwarded invitations.

At step 36 the client device 2 associated with the first user generates a reminder in advance of the scheduled start time for the selected television program; typically the reminder is generated five minutes in advance of the start time. A pop-up window is generated on the touch-screen 10 to remind the user about the group viewing event. A reminder is also generated at each client device 2 associated with the users that have accepted the invitation. Typically the reminder will prompt the user to change to the relevant television channel, whether the client device 2 is the television itself or an auxiliary device such as a tablet computer. In alternative arrangements where the client device 2 is a television the CPU 12 may be configured to re-tune to the relevant channel at the scheduled start time. Where the client device 2 is not a television it may send a command to an associated television causing it to re-tune to the relevant channel.

At step 38 the client device 2 launches an online chat application at the scheduled start time of the television program, or shortly before. An online chat application is also launched in each client device 2 associated with users that have accepted the invitation. In this way users can participate in a joint viewing event by discussing the television program on the online chat application. The online chat application includes a list of all of the participants. In some arrangements the presence of a contact in the list of participants may be taken as an indication that the contact has received and accepted an invitation.

Multiple groups may be provided in the online chat application. In one embodiment a single group is created for each invitation that is initiated. Thus, if a recipient decides to forward an invitation at step 34 this will create a group in the online chat application that is separate to the group created by the original invitation. Thus, a user can participate in a number of different group conversations with different and/or overlapping sets of contacts. The groups in the online chat application may be closed so that they are restricted to the contacts that have received invitations or they may be open so that any person can join. In one example the list of participants may be a combination of contacts that have received and accepted the invitation, and other users.

The invention has been described above in the context of a television program that is scheduled to be shown at a future time. In an alternative configuration the first user may select a television program that is currently being broadcast and send reminders to a selection of contacts.

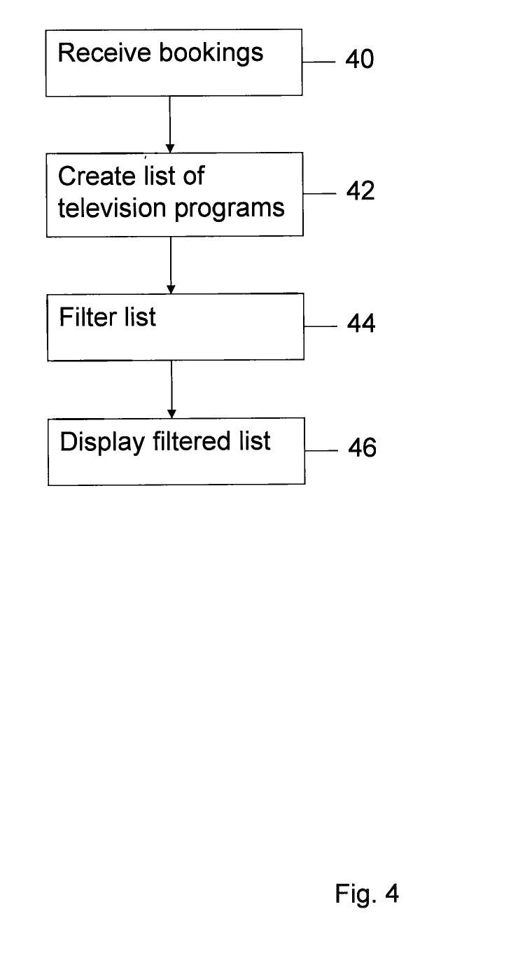

The server 4 is configured to maintain a record of each user that has booked to watch a particular television program. FIG. 4 shows a flow diagram having a number of steps that may be undertaken by the server 4 in an embodiment of the invention. At step 40 the server 4 is configured to receive a number of booking requests from individual users. These booking requests may be generated as a result of accepted invitations. Alternatively, booking requests they may be generated spontaneously by users selecting “book to watch” buttons 56 in a displayed EPG. At step 42 the server 4 is configured to create a list of television programs scheduled to be shown at future times and to rank the list in order of the number of bookings received. At step 44 the server 4 is configured to filter the list so that only a subset of television programs is included. In one arrangement the subset includes television programs having a start time within the next week, or within the next 24 hours. Alternatively, or in addition, television programs may be filtered by genre or so that only bookings generated by a particular group of individuals are taken into consideration. For example, a user may filter the list so that only bookings generated by their own friends are taken into consideration. At step 46 the filtered list of television programs is displayed to a user on a client device 2. In this way a user can review the most popular upcoming television programs in order of the number of users that have booked to view the program. This may be useful to the user in deciding their viewing schedule.

1-13. (canceled)

14. A computer system comprising:
an input module configured to receive a number of selections of television programs scheduled to be shown at respective future times;
one or more processors configured to create a list of television programs scheduled to be shown at respective future times, and to rank the list according to the number of selections each television program has received; and
a display configured to display the ranked list to a user.

15. The computer system of claim 14 wherein the selection of a television program involves setting a reminder to be notified in advance of the scheduled start time.

16. The computer system of claim 14 wherein the one or more processors are configured to list television programs scheduled to be shown within a predetermined time period.

17. The computer system of claim 14 wherein the one or more processors are configured to rank the list according to the number of selections each television program has received from a specific group of users.
